(19) United States
(12) Patent Application Publication
(10) Pub. No.: US 2024/0394554 A1
(43) Pub. Date: Nov. 28, 2024

(54) LEARNING DEVICE, LEARNING METHOD, CONTROL SYSTEM, AND RECORDING MEDIUM

(71) Applicant: NEC Corporation, Minato-ku, Tokyo (JP)

(72) Inventor: Takuya HIRAOKA, Tokyo (JP)

(73) Assignee: NEC Corporation, Minato-ku, Tokyo (JP)

(21) Appl. No.: 18/695,021

(22) PCT Filed: Oct. 4, 2021
(86) PCT No.: PCT/JP2021/036673

§ 371 Date: Mar. 25, 2024

(51) Int. Cl. G06N 3/092

(52) U.S. Cl. CPC G06N 3/092

(57) ABSTRACT

A learning device calculates each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and updates the policy model or the parameters of the policy model on the basis of the smallest of the plurality of second evaluation values and a first evaluation value, which is an index value indicating the result of evaluating the first action in the first state.

### TECHNICAL FIELD

The present invention relates to a learning device, a learning method, a control system, and a recording medium.

### BACKGROUND ART

One of the machine learning methods is Q-learning, which is a reinforcement learning method that determines measures using an optimized Q-function.

For example, Patent Document 1 describes performing reinforcement learning, called Q-learning, to optimize the maintenance range of the target for which maintenance is required.

### PRIOR ART DOCUMENTS

### Patent Document

Patent Document 1: PCT International Publication No. WO 2021/515930

### SUMMARY OF THE INVENTION

### Problems to be Solved by the Invention

The time required for reinforcement learning should be relatively short.

One of the purposes of the present invention is to provide a learning device, a learning method, a control system, and a recording medium that can solve the above-mentioned problems.

### Means for Solving the Problem

According to the first example aspect of the present invention, the learning device is a learning device provided with a model calculation portion that calculates each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and a model updating portion that updates the policy model or the parameters of the policy model on the basis of the smallest of the plurality of second evaluation values and a first evaluation value, which is an index value indicating the result of evaluating the first action in the first state.

According to the second example aspect of the invention, the control system is provided with a model calculation means that calculates each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and a model updating means that updates the policy model or the parameters of the policy model on the basis of the smallest of the plurality of second evaluation values and a first evaluation value, which is an index value indicating the result of evaluating the first action in the first state.

According to a third example aspect of the invention, the learning method is a method in which a computer calculates each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and updates the policy model or the parameters of the policy model on the basis of the smallest of the plurality of second evaluation values and a first evaluation value, which is an index value indicating the result of evaluating the first action in the first state.

According to the fourth example aspect of the invention, the recording medium is a recording medium that records a program for causing a computer to calculate each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and update the policy model or the parameters of the policy model on the basis of the smallest of the plurality of second evaluation values and a first evaluation value, which is an index value indicating the result of evaluating the first action in the first state.

### Effect of Inventions

According to the above learning device, control system, learning method, and recording medium, the time required for reinforcement learning can be reduced.

### BRIEF DESCRIPTION OF THE DRAWINGS

FIG. 1A is a diagram showing a configuration example of a control system according to the example embodiment.

FIG. 1B is a block diagram of the control system according to the example embodiment.

FIG. 2 is a diagram showing a configuration example of the evaluation model storage device according to the example embodiment.

FIG. 3 is a diagram showing a configuration example of the learning device according to the example embodiment.

FIG. 4 is a flowchart showing an example of the processing steps performed by the control system according to the example embodiment.

FIG. 5 is a diagram for illustrating the Q-function model in the example embodiment.

FIG. 6 is a configuration diagram of a Q-function model of one of the example embodiments.

FIG. 7 is a diagram for illustrating an example of a processing procedure in which the control system of the example embodiment updates the model.

FIG. 8 is a diagram showing the verification result in the example embodiment.

FIG. 9 is a diagram showing the verification result in the example embodiment.

FIG. 10 is a diagram showing the verification result in the example embodiment.

FIG. 11 is a diagram showing an example of a pendulum to be controlled in Example 1.

FIG. 12 is a diagram showing a configuration example of the section in a VAM plant according to Example 2.

FIG. 13 is a diagram showing a configuration example of the learning device according to the example embodiment.

FIG. 14 is a diagram showing a configuration example of the control system according to the example embodiment.

FIG. 15 is a diagram showing an example of the processing procedure in the learning method according to the example embodiment.

FIG. 16 is a schematic block diagram showing the configuration of a computer according to at least one example embodiment.

### EXAMPLE EMBODIMENT

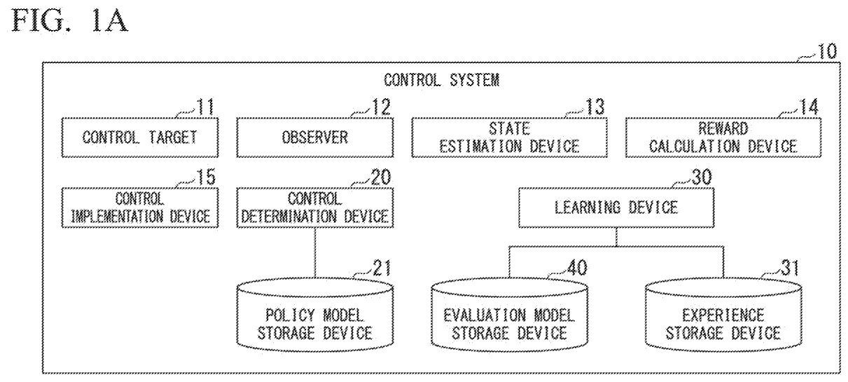

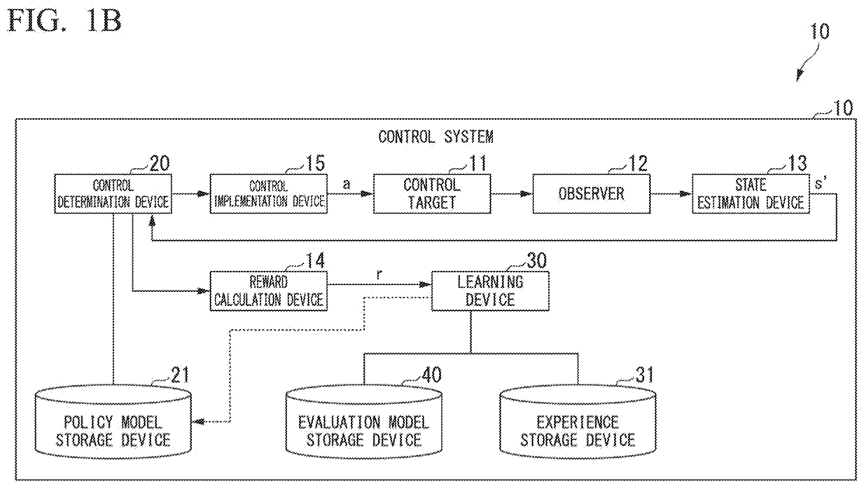

For example, when controlling a control target such as a chemical plant (described below in Example Embodiment 2), a robot (described below in Example Embodiment 3), manufacturing equipment, transportation equipment, and the like, the control device according to the example embodiment uses reinforcement learning to determine the control contents for the control target. The control target operates in accordance with the control contents. The control device can also be said to operate in a control system (FIG. 1) that performs control, for example.

As described below in Example Embodiment 2, the control device of the example embodiment determines, for example, the control contents for controlling a chemical plant based on a policy model calculated according to reinforcement learning.

Chemical plants are equipped with observation devices that measure temperature, pressure, and flow rate. The control device determines a policy model for determining the control contents for each device in the chemical plant based on the measurements taken by each observation device. The control device then determines the control contents according to the determined policy model and controls each device according to the determined contents.

As described below in Example Embodiment 3, the control device of the example embodiment determines, for example, the control contents that control the robot based on the policy model calculated according to reinforcement learning. The robot to be controlled has multiple joints. An observation device is installed in the system that controls the robot to measure the angles of joints, etc. The control device determines a policy model for determining the control contents about the robot based on the measurements taken by the observation device. The control device then determines the control contents according to the determined policy model and controls the robot according to the determined contents.

The application of the control device according to the example embodiment is not limited to the above-mentioned examples, and may be, for example, manufacturing equipment in a manufacturing plant, or transportation equipment.

### Explanation of Terms and Concepts

The following is an explanation of the terms and concepts used to describe the example embodiment.

Reinforcement learning is a method for obtaining a decision rule that maximizes the expected value of a cumulative reward in a Markov decision process with unknown state transition probabilities. A decision rule is also called a policy or a control rule.

A Markov decision process represents a repeated decision in which this sequence of events is repeated: “In a given state s, an action a is selected and executed according to policy T, the state transitions from s to s′ according to the state transition probability ρ(s′, r|s, a), and a reward r is given.”

A policy may probabilistically calculate an action. Alternatively, a delta distribution can be used to describe a policy that uniquely calculates the action. A policy that uniquely calculates an action is called a deterministic policy and is represented by a function such as aₜ=π(sₜ). In deterministic measures, the action a to be taken at state sₜ is determined to be one. aₜ denotes the action aₜ time t. π is a function indicating the policy. sₜ denotes the state at time t. That is, a policy can be considered as a model (or function) that calculates (or determines or selects) an action aₜ at time t from a state sₜ at time t.

The cumulative reward is the sum of the rewards earned over a period of time. For example, the cumulative reward Rₜ from some time t to (t+T) is expressed as in Expression (1).

$$[ Expression 1 ]$$

$${R}_{t} = {\sum }_{{t}^{′} = t}^{t + T} {r}_{{t}^{′}} {γ}^{{t}^{′} - t} \qquad ( 1 )$$

γ is a real constant for γ∈=[0, 1]. γ is also called the discount rate. rₜ is the reward at time t. For this cumulative reward, the conditional expected value of the cumulative reward with respect to the state transition probability ρ and policy π given the state sₜ and action aₜ time t is denoted as Q_{π}(sₜ, aₜ), and is defined as in Expression (2).

$$[ Expression 2 ]$$

$${Q}_{π} ( {s}_{t} , {a}_{t} ) ≡ {E}_{ρ , π} [ {R}_{t} \vert {s}_{t} , {a}_{t} ] \qquad ( 2 )$$

Q_{π}(sₜ, aₜ) in Expression (2) is called the Q-function (or action value function). E indicates the expected value.

The policy π that maximizes the value of Expression (3) for state s in a state set S containing multiple states is called the optimal policy.

$$[ Expression 3 ]$$

$${E}_{a ∼ π ( \cdot \vert S )} {Q}_{π} ( s , a ) \qquad ( 3 )$$

Here, the action a is assumed to be sampled from the policy π, which is denoted as a˜π(⋅|S).

By the way, reinforcement learning by the Q-learning method determines the parameters of the Q-function so that the best policy (optimal policy) is derived using the Q-function. The Q-function corresponding to the optimal measure is called the optimal Q-function. A model of the Q-function and a model of the policy are prepared, and through learning, the model of the Q-function is brought closer to the optimal Q-function and the model of the policy is brought closer to the optimal policy based on the model of the Q-function. In the following, the model of the Q-function will be referred to as the Q-function model and the model of the policy will be referred to as the policy model.

For example, the value y of the Q-function is shown in Expression (4).

$$[ Expression 4 ]$$

$$y ≡ r + γ {Q}_{\overline{ϕ}} ( {s}^{′} , {π}_{θ} ( {s}^{′} ) ) \qquad ( 4 )$$

y is also referred to as the correct label.
θ is a parameter of the policy model.
φ is a parameter of the Q-function model. φ with an overbar (hereafter referred to as φbar) is the target parameter for stabilizing the update of the Q-function model. The target parameter φbar is basically the value of φ in the past and is updated to the value of φ from time to time. While the value of the parameter φ is updated during learning and the Q-function using φ changes, delaying the update of the value of the target parameter φbar relative to the update of φ is expected to suppress rapid fluctuations in the value of the target y and stabilize learning.

Updating the value of a parameter is also referred to as updating the parameter. As the parameters of the model are updated, the model is also updated. Target parameters are updated as parameters are updated.

The Q-function model is labeled “Q_{φ}” with its parameter φ explicitly indicated. The Q-function indicated by the Q-function model Q_{φ} is also referred to as the Q-function Q_{φ}. If “φ” in “Q_{φ}” is a parameter variable, then “Q_{φ}” is a Q-function model with parameter φ. On the other hand, if “φ” in “Q_{φ}” is a parameter value, then “Q_{φ}” is the Q-function of the parameter φ.

The parameter θ of the policy π is explicitly denoted as “π_{θ}”. The policy indicated by the policy model π_{θ} is also referred to as policy π_{θ}. When “θ” in “π_{θ}” is a parameter variable, “π_{θ}” indicates the policy model. On the other hand, when “θ” in “π_{θ}” is the value of a parameter variable (hereinafter denoted as “parameter value”), “π_{θ}” indicates a policy.

The Q learning method in the example embodiment provides a method to mitigate overestimation by using multiple Q-function models.

### Configuration in the Example Embodiment

FIG. 1A is a diagram showing a configuration example of the control system according to the example embodiment. FIG. 1B is a block diagram of the control system according to the example embodiment.

In the configuration shown in FIG. 1A, a control system 10 is provided with an observer 12, a state estimation device 13, a reward calculation device 14, a control implementation device 15, a control determination device 20, a policy model storage device 21, a learning device 30, an experience storage device 31, and an evaluation model storage device 40.

A control target 11 is the object to be controlled. Various controllable things (e.g., chemical plants, robots) can be used as the control target 11. The control target 11 may be part of the control system 10. Alternatively, the control target 11 may be a configuration external to the control system 10.

The observer 12 observes the state of the control target 11. The information output by the observer 12 is information about the state of the control target 11. When the control system 10 is a chemical plant, the observer 12 is a sensor such as a temperature sensor, humidity sensor, pressure sensor, and the like. When the control system 10 is a robot, the observer 12 is, for example, an imaging device that captures images of the robot and the robot's surroundings, a global positioning system (GPS) that locates the robot's position, or other observation equipment.

The state estimation device 13 estimates the state of the control target 11 based on the information obtained from the observer 12.

The control determination device 20 and the control implementation device 15 are examples of a control determination means.

The control determination device 20 selects the policy model and policy π by referring to the state estimated by the state estimation device 13 and the policy model stored in the policy model storage device 21, and then calculates the policy π to output the control value. The selection of the policy model and the policy x are described below.

The control implementation device 15 controls the control target 11 according to the control value output by the control determination device 20.

For example, the control determination device 20 generates control values based on a predetermined control side so that, based on a control objective and a state of the control target 11 relative to this control objective, the difference between the control objective and the state estimated by the state estimation device 13 is reduced. The state of the control target 11 may be either or both the state detected by the observer 12 or the state estimated by the state estimation device 13. FIG. 1 illustrates the case where the state estimated by the state estimation device 13 is used as the state of the control target 11, but is not limited thereto. The control determination device 20 may use an externally supplied control objective, may generate a control objective itself, or may use a predetermined control objective.

Furthermore, the control determination device 20 selects a policy model by referring to the policy model storage device 21, and uses the policy model to determine the predetermined control side described above.

The policy model storage device 21 stores a policy model that outputs control values in response to state inputs. For example, the policy model storage device 21 stores the policy model including the parameter variable θ and the value of the parameter variable θ. Hereinbelow, the policy model including the parameter variable θ is referred to as the policy model body. The policy model is obtained by setting a value for the parameter variable θ in the policy model body. This policy model is registered by learning using the learning device 30 described below.

The reward calculation device 14 is used, for example, for learning by the learning device 30. The reward calculation device 14 obtains the reward according to the “point (reward) calculation rule for the state” specified by the user, for example. However, the method by which the reward calculation device 14 obtains the reward is not limited to any particular method. The reward calculation device 14 can use a variety of methods to obtain state-based rewards.

For example, the reward calculation device 14 may calculate the reward using the information output by the observer 12 or information output by the state estimation device 13 when obtaining the reward.

When the control target 11 is in state s, action a is determined based on the policy. By executing action a under that state s, the state of the control target 11 transitions from state s to state s′. In response, the reward calculation device 14 calculates an index value according to the degree of goodness or badness of the state s′. This index value is called the reward. In this regard, a reward can be said to be an index value representing the goodness (or effectiveness, value, or desirability) of a certain action in a given state. In this case, the better the reward, the better the action, and the worse the reward, the worse the action.

Alternatively, the index value may be a penalty. In this case, the index value can be said to be an indicator of the inappropriateness of the action in a given state. In this case, the more the penalties, the worse the action, and the fewer the penalties, the better the action.

Reward corresponds to an example of the first action evaluation value. The first action evaluation value here is the evaluation value of the first action in the first state. The first action evaluation value is also referred to as the first evaluation value.

The learning device 30 one by one adds to/records in for example, the experience storage device 31 the state s output by the state estimation device 13, the action a of the control target by the control value output by the control determination device 20, the reward r output by the reward calculation device 14, and the state output by the state estimation device 13 after the action a by the control of the control implementation device 15 (i.e., the set of states s′ (s, a, r, s′) after state transition, also denoted as “experience”). One by one here is, for example, each time the control implementation device 15 performs a control on the control target 11. The learning device 30 need not add (or record) an experience to the experience storage device 31 one by one.

The learning device 30 then updates the policy model storage device 21 and the evaluation model storage device 40 by referring to the policy model storage device 21, the evaluation model storage device 40, and the experience storage device 31. Specifically, the learning device 30 updates the parameters of these models by referring to the models and experiences stored by these storage devices.

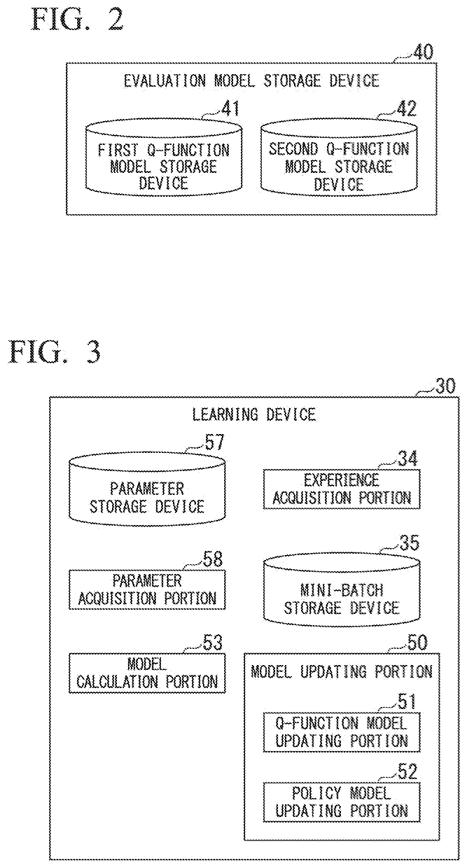

FIG. 2 is a diagram showing an example of the configuration of the evaluation model storage device 40. In the configuration shown in FIG. 2, the evaluation model storage device 40 is provided with, for example, a first Q-function model storage device 41 and a second Q-function model storage device 42.

The first Q-function model storage device 41 stores the parameter φ₁ of the first Q-function model described above. The second Q-function model storage device 42 stores the parameter φ₂ of the second Q-function model described above.

The evaluation model storage device 40 stores the Q-function model body common to the first and second Q-function models. Either or both of the first Q-function model storage device 41 and the second Q-function model storage device 42 may be used to store the Q-function model bodies. Alternatively, the evaluation model storage device 40 may have a different storage area than the first Q-function model storage device 41 and the second Q-function model storage device 42 to store the Q-function model body.

In this way, the evaluation model storage device 40 stores two Q-function models that are used to evaluate the performance of the policy recorded in the policy model storage device 21 and to mitigate the overestimation problem of the Q-function model described above. In particular, the evaluation model storage device 40 stores the parameters for each of these two Q-function models.

As described above, the case is illustrated in which multiple Q-function models that differ from each other can be constituted by applying independently determined parameter values to a common Q-function model body. This results in multiple Q-function models, each outputting a unique value. In the following explanation, the explanation regarding the use of this Q-function model body may be omitted and replaced with the application of each Q-function model.

FIG. 3 is a diagram that shows an example of the configuration of the learning device 30. In the configuration shown in FIG. 3, the learning device 30 has an experience acquisition portion 34, a mini-batch storage device 35, a model updating portion 50, and a model calculation portion 53. The model updating portion 50 has a Q-function model updating portion 51 and a policy model updating portion 52.

The experience acquisition portion 34 samples experiences from the experience storage device 31 according to predetermined criteria to constitute a mini-batch. When constituting a mini-batch, the index of each experience is also included. This is to confirm which experiences within the mini-batch correspond to experiences stored in the experience storage device 31. This experience acquisition portion 34 is an example of an experience acquisition means. For example, selection criteria such as, for example, the number of experiences to be sampled, the size of the mini-batch (or the number of experiences within the mini-batch), and a predetermined priority order for sampling may be applied as predetermined criteria for the sampling described above. A predetermined priority order may be used, such as prioritizing those that have been sampled for a relatively small period of time.

The model of the Q-function in the example embodiment consists of a combination of the aforementioned multiple function models.

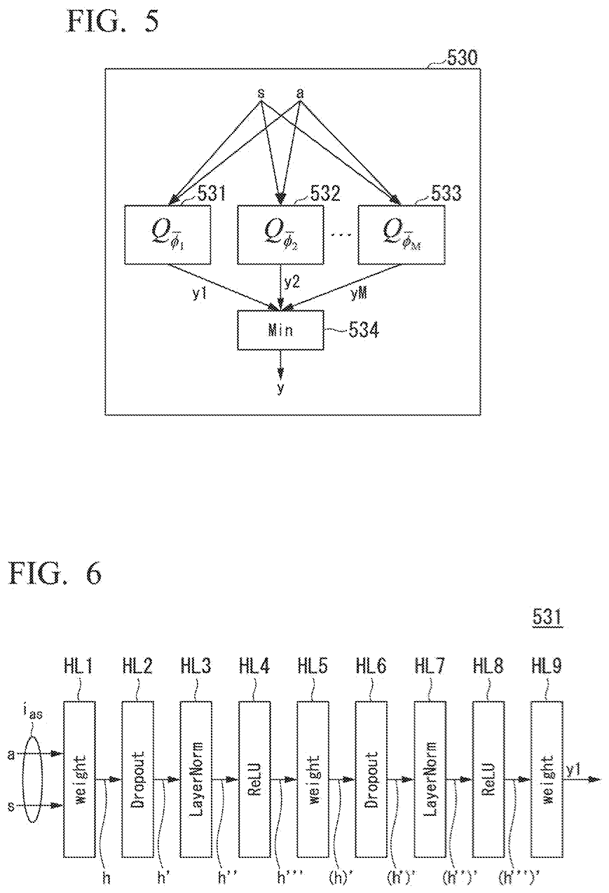

FIG. 5 is a diagram showing an example of a model of the Q-function of the example embodiment. FIG. 6 is a diagram showing the Q-function model of one of the example embodiments.

The Q-function model 530 has a plurality of Q-function models and an evaluator 534.

For example, the first first_Q-function model of the plurality of Q-function models is specified as the Q-function Q_{φbar1}. The second_Q-function model is specified as Q-function Q_{φbar2}. The last M-th M_Q-function model is specified as the Q-function Q_{φbarM}. The number of Q-function models, M, is an integer greater than or equal to 2 and may be determined as appropriate. For example, a value of M of 2 would result in a configuration that uses 2 Q-function models, and a value of M of 3 would result in a configuration that uses 3 Q-function models. Thus, it is possible to configure the system to use three or more Q-function models depending on the value of M. The following implementation will focus on a configuration that utilizes two Q-function models to simplify the explanation.

Each Q-function model uses data about some state s and data about some action a as input data. Each Q-function model performs operations using the parameters of the Q-function model based on the data about the state s and the data about a certain action a, and calculates the evaluation value for each of them. The data regarding action a is an example of data indicating policy information pertaining to the first action, and the data regarding state s is an example of data regarding state information pertaining to the first state.

For example, the aforementioned multiple Q-function models include multiple operation blocks, each corresponding to Q-function Q_{φbar1} through Q-function Q_{φbarM}. For example, Q-function Q_{φbar1} is assigned to operation block 531, Q-function Q_{φbar2} is assigned to operation block 532, and Q-function Q_{φbarM} is assigned to operation block 533. The operation block 531 calculates y1 by performing the specified Q-function Q_{φbar1} operation using the parameter φbar1 of the Q-function model. The operation block 532 calculates y2 by performing the specified Q-function Q_{φbar2} operation using the parameter φbar2 of the Q-function model. The operation block 533 calculates yM by performing the specified Q-function Q_{φbarM} operation using the parameter φbarM of the Q-function model. y1 to yM are scalars.

The evaluator 534 selects the minimum value among the individually calculated y1 to yM and outputs the selection result as target y.

In general, increasing the number of multiple Q-function models increases the tendency to mitigate overestimation, but also increases the computational load.

Although the present example embodiment uses multiple Q-function models, with respect to the aforementioned tendency, an example that enables a relatively smaller number of Q-function models will be described. In the description of the example embodiment, the case in which two Q-function models are used is illustrated as a typical case.

Note that overestimation of the Q-function is mitigated by adopting the smaller of the two Q-function model output values, y1 and y2. In other words, this reduces the time required for learning because model updates are more stable.

Next, an example of a Q-function is shown in FIG. 6. Here is an example of the operation block 531 corresponding to the first first Q-function model. The operation block 532 may be configured in the same manner as the operation block 531.

The Q-function Q_{φbar1} has hidden layers HL1 through HL9. If the left side shown in FIG. 6 is the input side and the right side is the output side, the hidden layers HL1 through HL9 are arranged in series from the input side to the output side. The process by the hidden layers HL1 through HL9 proceeds along the arrows from left to right in FIG. 6.

The hidden layer HL1 is the first weight operation layer (weight) that performs the first weight operation.

Vector ias, the input vector to the hidden layer HL1, is formed by combining the state s and action a, each of which is represented by a vector, as shown in Expression (5). The hidden layer HL1 calculates the hidden vector h from the vector ias. For example, the hidden layer HL1 calculates the hidden vector h by multiplying the transposed vector of vector ias by the first weight matrix W, as shown in Expression (6). The subscript T is the operator of the transposed vector.

$$[ Expression 5 ]$$

$${i}_{a s} = a \vert \vert s \qquad ( 5 )$$

$$[ Expression 6 ]$$

$$h = W {i}_{as}^{T} \qquad ( 6 )$$

The hidden layer HL2 performs a computational process that does not reflect some of the values of each element of the input vector, vector h, in the evaluation value of the Q function Q_{φbar1} (called dropout operations), generating the output vector, vector h′. The hidden layer HL2 is an example of a dropout operation layer (dropout) that performs the first dropout operation. The dropout operation layer performs a dropout operation in which a part of the calculation results based on the policy information (information pertaining to the policy model) for transitioning the state of the control target and the state information of the control target are not reflected in the evaluation value.

For example, the hidden layer HL2 changes some of the values of each element of the input vector h to 0 probabilistically. The value of an element that is not changed to 0 may be the same as the value of each element of vector h. More specifically, the hidden layer HL2 generates a random number value (rand) for each element of vector h, each of which takes a value in the range of 0 to 1, and when the value of each random number is below a predetermined threshold (dropout rate), the value of the element is set to 0, while the values of elements that do not meet this criterion are maintained. The hidden layer HL2 then outputs the result of the computational process as a vector h′. The size of the vector h and the size of vector h′ are the same.

For example, the computational process by the hidden layer HL2 is shown in Expression (7). Dropout (⋅) denotes the function of the dropout operation on the vector.

$$[ Expression 7 ]$$

$${h}^{′} = Dropout ( h ) \qquad ( 7 )$$

If the i-th element of vector h is denoted by hi and the i-th element of vector h′ is denoted by h′ᵢ, the above relationship is defined as in Expression (8) below. As shown in this Expression (8), hi may be replaced by 0 based on the value of a random number (rand). The substitution to 0 can be regarded as noise (called the first noise) for the normal value.

$$[ Expression 8 ]$$

$${h}_{i}^{′} = \{ \begin{matrix}{h}_{i} & if rand > dropout rate \\ 0 & otherwise\end{matrix} \qquad ( 8 )$$

The hidden layer HL3 performs an operation to normalize the input vector, vector h′, to produce an output vector, vector h″. The hidden layer HL3 is provided at the rear of the hidden layer HL2, which performs the dropout operation described above. Based on the output of the hidden layer HL2 (dropout operation layer), the hidden layer HL3 includes a layer normalization layer that normalizes the values of elements included in that output.

For example, the hidden layer HL3 performs an operation on the vector h′ to compute the mean and standard deviation of each element of the vector h′ to normalize it so as to produce the output vector, h″. The normalizing operation is, for example, the process of dividing the difference between the element value and the mean by the standard deviation, as shown in Expression (10). The hidden layer HL3 then outputs the result of the computational process as the vector h″. The size of the vector h and the size of vector h′ are the same. The computational process by the hidden layer HL3 is shown in Expression (9). LayerNorm (⋅) denotes the function of the normalization operation. An example of a more specific arithmetic formula is shown in Expression (10). |h′| in Expression (10) indicates the number of elements in the vector h′.

$$[ Expression 9 ]$$

$${h}^{″} = LayerNorm ( {h}^{′} ) \qquad ( 9 )$$

$$[ Expression 10 ]$$

$${h}_{i}^{″} = \frac{{h}_{i}^{′} - \frac{1}{\vert {h}^{′} \vert} {\sum }_{j = 1}^{\vert {h}^{′} \vert} {h}_{j}^{′}}{\sqrt{{\sum }_{k = 1}^{\vert {h}^{′} \vert} {( {h}_{k}^{′} - {\sum }_{j = 1}^{\vert {h}^{′} \vert} - {h}_{j}^{′} )}^{2}}} \qquad ( 10 )$$

The hidden layer HL4 performs an operation that applies an activation function to the input vector, vector h″, to generate the output vector, vector h′″. The hidden layer HL4 is located after the hidden layer HL4, which performs the standardization operation described above. For example, the hidden layer HL4 includes an activation function operation layer that performs an operation to apply a ReLU (Rectified Linear Unit) function, including a ramp function, to the output of hidden layer HL3 (standardized operation layer). The computational process by the hidden layer HL4 is shown in Expression (11). ReLU (⋅) indicates the activation function. A more specific example of the arithmetic equation is shown in Expression (12). The hidden layer HL4 then outputs the result of the computational process as vector h′″. The size of vector h′″ is the same as the size of vector h′″. The hidden layer HL4 is an example of an identification layer that identifies the output of the layer standardization layer, which is hidden layer HL3.

$$[ Expression 11 ]$$

$${h}^{′′′} = ReLU ( {h}^{″} ) \qquad ( 11 )$$

$$[ Expression 12 ]$$

$${h}_{i}^{′′′} = \{ \begin{matrix}{h}_{i}^{″} & if {h}_{i}^{″} > 0 \\ 0 & otherwise\end{matrix} \} \qquad ( 12 )$$

Next, hidden layers HL5 through HL8 are explained. The hidden layer HL5 performs the same computational process as the hidden layer HL1 described above. The hidden layer HL6 performs the same computational process as the hidden layer HL2 described above. The hidden layer HL7 performs the same computational process as the hidden layer HL3 described above. The hidden layer HL8 performs the same computational process as the hidden layer HL4 described above. The input vectors, output vectors, coefficients of internal operations, thresholds, and sizes of input and output vectors in each of the hidden layers HL5 through HL8 are mutually different from those in hidden layers HL1 through HL4.

For example, the hidden layer HL5 takes the vector h′″ generated by the hidden layer HL4 as its input vector. The hidden layer HL5 is the second weight operation layer (weight) that performs the second weight operation. The processing in the hidden layer HL5 is the same as the computational processing shown in Expression (6), but differs from the processing in the hidden layer HL1 in that the vector ias in Expression (6) is the vector h′″, the weight matrix used for the second operation is the second weight matrix W, and the vector h in Expression (6) is the vector (h)′. The size and element values of the second weight matrix W may be different from those of the first weight matrix W.

Similarly, each of the aforementioned equations can be applied to each of the calculations for hidden layers HL6 through HL8.

For example, the processing in the hidden layer HL6 is similar to the computational processing shown in Expression (7), but differs from the processing in the hidden layer HL2 in that the vector h in Expression (7) is the vector (h)′, and the vector h′ in Expression (7) is the vector (h′)′.

The processing in the hidden layer HL7 is similar to the computational processing shown in Expression (9), but differs from the processing in the hidden layer HL3 in that the vector h′ in Expression (9) is the vector (h′)′, and the vector h″ in Expression (9) is the vector (h″)′.

The processing in the hidden layer HL8 is similar to the computational processing shown in Expression (11), but differs from the processing in the hidden layer HL4 in that the vector h″ in Expression (11) is the vector (h″)′, and the vector h′″ in Expression (11) is the vector (h″)′.

Note that the detailed explanations relating to the application of Expressions (8), (10), and (12) above are omitted, but referring to the explanations of Expressions (7), (9), and (11) above can be helpful in utilizing Expressions (8), (10), and (12).

This completes the operation of the hidden layer HL8, resulting in vector (h′″)′ to replace the vector h′″.

The hidden layer HL9 is the third weight operation layer (weight) that performs the third weight operation.

The input vector to the hidden layer HL9 is a vector (h′″)′ similar to the vector h′″ calculated by Expression (13) and Expression (13). The hidden layer HL9 calculates a scalar value using the vector (h′″)′ and a predetermined weight vector. The scalar value calculated by the hidden layer HL9 is treated as the output of the Q-function.

$$[ Expression 13 ]$$

$$y 1 = {W [ {( {h}^{′′′} )}^{′} ]}^{T} \qquad ( 13 )$$

The Q-function, which includes the above computational processing, is used for the computational processing according to the example embodiment.

The model updating portion 50 updates the parameters φ₁, φ₂, and θ by referring to the mini-batch stored by the mini-batch storage device 35. The model updating portion 50 is an example of a model updating means.

As mentioned above, the parameter φ₁ is a parameter of the first Q-function model. The first Q-function model storage device 41 stores the parameter φ₁. The parameter φ₂ is a parameter of the second Q-function model. The second Q-function model storage device 42 stores the parameter φ₂. The policy model storage device 21 stores the parameter θ.

The Q-function model updating portion 51 updates the parameters φ₁ and φ₂. The Q-function model updating portion 51 is an example of an evaluation model updating means.

The policy model updating portion 52 updates the parameter θ The policy model updating portion 52 is an example of a policy model updating means.

The model calculation portion 53 calculates values for each of the first Q-function model, the second Q-function model, and the policy model. For example, when the Q-function model updating portion 51 updates each of the first and second Q-function models, the model calculation portion 53 calculates values for each of the first Q-function model, second Q-function model, and policy model. The model calculation portion 53 is an example of a model calculation means. For example, the model calculation portion 53 performs weighting operations on the above policy information and the above state information, adds noise to the result of the weighting operations, normalizes the value of the calculation result to which noise has been added, identifies the normalized result according to predetermined identification rules, and generates evaluation values indicating learning status based on the results of that identification (identification results) using a first Q-function model and a second Q-function model (Q-function). The model calculation portion 53 generates evaluation values indicating learning status using the first Q-function model and the second Q-function model (Q-function) described above. Details of this are discussed below.

The parameter storage portion 57 stores hyper parameters used in the learning process.

The parameter acquisition portion 58 acquires the above hyperparameters and adds them to the parameter storage portion 57. Hyperparameters are parameters determined by the user or others among parameters used in the learning process. For example, scenarios, modes of operation, etc. are specified by the user or others. The above scenarios and modes of operation are associated with a hyperparameter capable of identifying them. The learning device 30 uses this hyperparameter to perform the learning process in the desired scenario and operating mode. Parameter G, described below, is an example of a hyperparameter.

More specifically, for example, the parameter acquisition portion 58 receives and acquires at least some of the following information: the number of Q-functions involved in model updating, the number of operation layers in the Q-function that add noise (dropout operation layers), the number of layer normalization layers in the Q-function that normalize the output based on the output of the previous layer, and the of times value propagation operations are performed according to the operating mode of the control target 11.

### <Processing in the Example Embodiment>

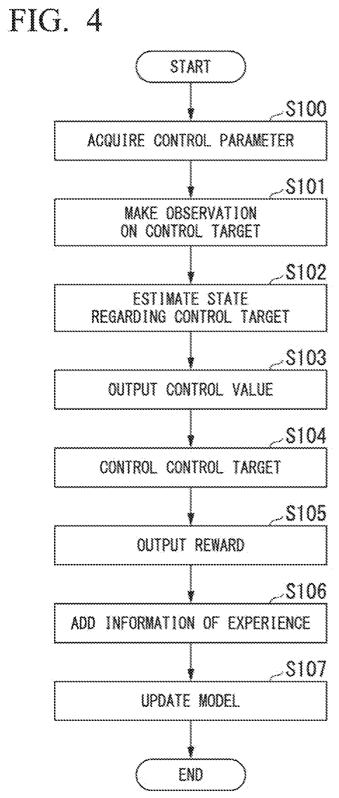

FIG. 4 is a flowchart showing an example of the processing steps performed by the control system 10. The control system 10 repeats the process in FIG. 4.

In the process of FIG. 4, the control system 10 obtains the control parameter (parameter G of the learning process) associated with the scenario, operation mode, etc., specified by the user or the like by the learning device 30 (Step S100) and stores it as a control parameter in the parameter storage portion 57. This parameter G is an example of a hyperparameter. Under the conditions specified by the parameter G, the control system 10 performs the following processes.

The observer 12 makes observations on the control target 11 (Step S101). For example, the observer 12 observes the control target 11 and the surrounding environment thereof.

Next, the state estimation device 13 estimates the state regarding the control target 11 based on the observation information of the observer 12 (Step S102). For example, the state estimation device 13 estimates states that may affect the control of the control target 11, such as estimating states that include the control target 11 and the surrounding environment thereof.

Next, the control determination device 20 determines the action to be taken in the above estimated state according to the state estimated by the state estimation device 13 and the policy model obtained by referring to the policy model storage device 21, and calculates control values according to the determined action (Step S103). Next, the control implementation device 15 implements control of the control target 11 in accordance with the control values output by the control determination device 20 (Step S104).

Next, the reward calculation device 14, referring to state estimated by the state estimation device 13 and the control value output by the control determination device 20, calculates the reward based on for example the estimated value of the state of the control target 11 and the observation result or state estimation result of the control outcome based on the control value mentioned above (Step S105). As an example of the above, the reward calculation device 14 may use the square error between the control objective value, which is the basis of the control value, and the detected value from the observation result to calculate the reward.

Next, the learning device 30 adds, records the set of the state estimated by the state estimation device 13, the control value output by the control determination device 20, and the reward output by the reward calculation device 14 as experience in the experience storage device 31 (Step S106).

Next, the learning device 30 updates these models by referring to the policy model stored in the policy model storage device 21, the Q-function model stored in the evaluation model storage device 40, and the experience stored in the experience storage device 31 (Step S107). Specifically, the policy model updating portion 52 updates the parameter θ of the policy model stored in the policy model storage device 21. The Q-function model updating portion 51 updates the parameters φ₁ and φ₂ of the Q-function model stored in the evaluation model storage device 40.

After Step S107, control system 10 terminates the process in FIG. 4. As described above, the control system 10 repeats the series of steps S101 through S107 again.

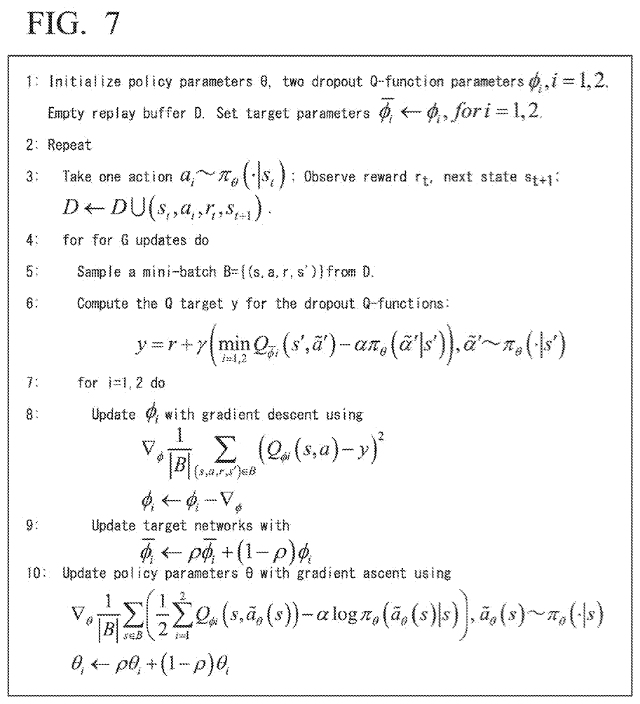

FIG. 7 is a diagram for illustrating an example of a processing procedure in which the control system 10 of the example embodiment updates the model. The control system 10 may perform the process in FIG. 6 using the algorithm shown in FIG. 7.

### Step S1:

The learning device 30 initializes the policy parameter θ and the two dropout Q-function parameters φ₁ and φ₂, empties the replay buffer D, and sets the target parameters φbar1 and φbar2 using the parameters φ1 and φ2.

### Step S2:

The learning device 30 repeats the following process.

### Step S3:

The learning device 30 determines the action aᵢ based on the probability π_{θ}(⋅|sᵢ) determined by the policy π_{θ} in state sᵢ, and performs control to ensure the determined action aᵢ is executed. The learning device 30 observes the reward rᵢ based on the result of that action aᵢ and the next state sᵢ₊₁ and generates empirical data correlating these pieces of information. The learning device 30 adds this empirical data to the replay buffer D. The empirical data to be added is shown in Expression (14). The empirical data to be added would, for example, be the results of observations of events occurring in real time. The learning device 30 stores this as time history information in the experience storage device 31. Each piece of empirical data may be assigned a uniquely identifiable identifier k.

$$[ Expression 14 ]$$

$$D ← D ⋃ ( {s}_{t} , {a}_{t} , {r}_{t} , {s}_{t + 1} ) \qquad ( 14 )$$

### Step S4:

The learning device 30 repeats the process from Step S5 to Step S9 by updating the hyperparameter G.

### Step S5:

The learning device 30 extracts the specific mini-batch B mapped to the hyper-parameter G from the empirical data stored in the replay buffer D of the experience storage device 31. The extracted mini-batch B is shown in Expression (15). The s, a, r, and s′ in this Expression (15) correspond to state sₜ, action aᵢ, reward rᵢ, and state sₜ₊₁ of the empirical data contained in the extracted mini-batch B, respectively. The empirical data of this mini-batch B may include a data set for experiences observed over a given period of time.

$$[ Expression 15 ]$$

$$B = \{ ( s , a , r , {s}^{′} ) \} \qquad ( 15 )$$

### Step S6:

The learning device 30 computes the target y of the dropout Q-function based on the extracted mini-batch B according to Expression (16) below. The dropout Q-function is an example of the Q-function shown in FIG. 6 above. In the following description, the dropout Q-function is referred to simply as the Q-function. Q-functions in the example embodiment not specifically mentioned are not general Q-functions, but rather dropout Q-functions.

$$[ Expression 16 ]$$

$$y = r + γ ( {min}_{i = 1 , 2} {Q}_{\overline{ϕ} i} ( {s}^{′} , {\tilde{a}}^{′} ) α {π}_{θ} ( \tilde{α} \text{'} \vert {s}^{′} ) ) , \tilde{α} \text{'} ∼ {π}_{θ} ( \cdot \vert {s}^{′} ) \qquad ( 16 )$$

The second term on the right side of this Expression (16) is an example of an arithmetic equation for the Q-function applying maximum entropy RL (reinforcement learning). The second term in the small parentheses in the second term on the right-hand side is the entropy term. The entropy term is adjusted so that the magnitude of the result of the calculation of this term is adjusted to give an appropriate amount of fluctuation to the value of the so-called Q-function in the first term in the same small parentheses. This prevents falling into local solutions compared to general reinforcement learning, which uses the Q-function in Expression (4) above by itself. The variation (noise) added by the aforementioned dropout Q-function can be defined as the first noise, and the variation (noise) due to this entropy term can be defined as the second noise. The target y calculated by the above Expression (16) contains the above two variation (noise) components.

### Step S7:

The learning device 30 switches the value of the identification variable i to either 1 or 2, and controls the operations in steps S8 and S9, respectively.

### Step S8:

The learning device 30 updates the parameters φ1 and φ2 by the steepest descent method using Expression (17). The learning device 30, for example, selects the one with the smaller value in the upper equation of Expression (17) out of the two Q-functions. The lower part of Expression (17) is the equation for updating the parameter φi using the values of the upper equation.

$$[ Expression 17 ]$$

$${∇}_{ϕ} \frac{1}{\vert B \vert} {\sum }_{( s , a , r , {s}^{′} ) ∈ B} {( {Q}_{ϕ i} ( s , a ) - y )}^{2} {ϕ}_{i} ← {ϕ}_{i} - {∇}_{ϕ} \qquad ( 17 )$$

### Step S9:

The learning device 30 updates the target parameters φbar1 and φbar2 using the operational expression shown in Expression (18) and the Q network parameters φ1 and φ2, respectively. ρ is a predetermined constant.

$$[ Expression 18 ]$$

$$\overline{{ϕ}_{i}} ← ρ \overline{{ϕ}_{i}} + ( 1 - ρ ) {ϕ}_{i} \qquad ( 18 )$$

### Step S10:

The learning device 30 updates the policy parameters θ using the mountain-climbing method with a gradient based on the operational expression shown in Expression (19). ρ is a predetermined constant.

$$[ Expression 19 ]$$

$${∇}_{θ} \frac{1}{\vert B \vert} {\sum }_{s ∈ B} ( \frac{1}{2} {\sum }_{i = 1}^{2} {Q}_{ϕ i} ( s , {\tilde{a}}_{θ} ( s ) ) - α log {π}_{θ} ( {\tilde{a}}_{θ} ( s ) \vert s ) ) , {\tilde{a}}_{θ} ( s ) ∼ {π}_{θ} ( \cdot \vert s ) \\ {θ}_{i} ← ρ {θ}_{i} + ( 1 - ρ ) {θ}_{i} \qquad ( 19 )$$

Note that B in Expression (19) is the mini-batch of experience sampled from the experience storage device that stores experiences. “|B|” is the size of the mini-batch. “Experience” refers to a state transition that occurred in the past. This experience is represented by (s, a, r, s′), which is a combination of state s, action a for state s, reward r for action a, and the next state s′ for the action a. Expression (15) above shows the experience (s, a, r, s′) contained in mini-batch B.

Since the target y depends on the parameter φbar, which changes during learning, the target y changes during the optimization run of the Q-function model.

A deterministic policy is assumed for the policy model π_{θ}, and the parameter θ is updated so as to output a that maximizes Q_{φ} with another update rule.

When using a general Q-function in the comparison example, one of the factors that makes learning that Q-function time-consuming is a problem called the overestimation problem of the Q-function. The problem with the overestimation of the Q-function is the Qφbar(s′, π_{θ}(s′)) part of Expression (4). When the target parameter φbar and the synchronization source parameter φ do not adequately approximate the true Q-function Q_{πθ} as the expected value of the cumulative reward for the policy π_{θ}, since π_{θ}(s) “outputs a that maximizes Q_{φ}, which is not adequately approximated,” the output value of the Q-function model will be overbiased such that it becomes larger than the output value of the true Q-function.

Therefore, in the example embodiment, two Q-function models are prepared, and the output values thereof are compared, with the smaller output value being adopted to mitigate overestimation of the Q-function. In other words, this is expected to reduce the time required for learning as model updates become more stable.

The following is an example of a case in which multiple Q-function models are constructed by applying different parameter values to the same Q-function model body.

Expressions (17) through (19) represent update rules for the parameter φᵢ of the Q-function model. In the example embodiment, the rules are applied to the two parameters φ1 and φ2, respectively. Since there are two Q-function models, φbar₁ and φbar₂ are used for target parameters, respectively, and the target parameter with the smaller output value is used to calculate the teacher signal.

The “Qφbar;” in Expression (18) indicates the application of the state s′ and the action π_{θ}(s′) obtained by applying the state s′ to the policy π_{θ} to the Q-function model Qφbarᵢ. This “Qφbarᵢ” indicates the conditional expected value of the cumulative reward given state s′ and the action π_{θ}(s′) in response to state s′. In this respect, the Q-function model Qφbar; can be said to be a model that evaluates (or estimates) the goodness (or value, effectiveness, or desirability) of the action π_{θ}(s′) in state s′. The value of the Q-function model Qφbarᵢ can be said to be the index value of the goodness (or value, effectiveness, or desirability) of the action π_{θ}(s′) in state s′.

State s is an example of the first state. Action a is an example of the first action. If the control target performs the first action, action a, in state s, which is the first state, the transition destination state s′ is an example of the second state. The action π_{θ}(s′) obtained by applying the second state, state s′, to the policy π_{θ} is an example of the second action.

The Q-function Qφbarᵢ corresponds to an example of a second action evaluation function. The second action evaluation function here is a function that calculates the evaluation value of the second action in the second state.

The Q-function value Qφbarᵢ, obtained by applying the state s′ and action π_{θ} (s′) to the Q function, corresponds to an example of the second action evaluation value. The second action evaluation value here is the evaluation value of the second action in the second state. The second action evaluation value is also referred to as the second evaluation value.

The Q-function model Qφbarᵢ corresponds to an example of a second action evaluation function model. The second action evaluation function model here is a model of the second action evaluation function. The parameter value of the second action evaluation function model is determined, whereby the second action evaluation function model represents one second action evaluation function.

However, the evaluation means of the second action in the example embodiment is not limited to that presented in the form of a function (second action evaluation function). Various means that can output an evaluation value of the second action in response to the input of the second state and the second action can be used as the evaluation means of the second action. For example, the evaluation means of the second action may output a fluctuating evaluation value, such as white noise. In this case, the evaluation means of the second action may output different evaluation values for the input of the same second state and second action. Thus, the second action evaluation value in the second state of the example embodiment (the second evaluation value) contains noise. The Q-function Qφbarᵢ and the Q-function model Qφbarᵢ are both configured to add clutter to the evaluation value of the second action described above.

Since the evaluation means of the second action is not limited to that presented in the form of a function, the evaluation model of the second action in the example embodiment is also not limited to a model presenting a function (second action evaluation function model). Thus, the evaluation model of the second action, which is not limited to a model representing a function, is referred to as the second action evaluation model or simply the evaluation model.

The Q-function model Qφbarᵢ is also an example of a function model.

As described above, the model calculation portion 53, based on the state s′ according to the action a in state s of the control target 11 and the action π_{θ}(s′) calculated from the state s′ using the policy model π_{θ}, uses the two Q-function models Qφbar₁ and Qφbar₂ that calculate the Q-function values Qφbar₁(s′, π_{θ}(s′)) and Qφbar₂ (s′, π_{θ}(s′)), which are index values of the goodness of action π_{θ}(s′) in state s′, to calculate the respective Q function values.

As mentioned above, state s is an example of the first state. Action a is an example of the first action. State s′ is an example of the second state. The action π_{θ}(s′) is an example of the second action. The Q-function values Qφbar₁ and Qφbar₂ correspond to examples of second evaluation value. The Q-function models Qφbar₁ and Qφbar₂ correspond to examples of the evaluation model.

The model updating portion 50 updates the Q-function models Qφbar₁ and Qφbar₂ based on the smaller of the Q-function values Qφbar₁ and Qφbar₂ and the reward r. The reward r corresponds to an example of the first evaluation value, which is an index value of the goodness of the action a in state s.

Thus, by using multiple Q-function models to learn each Q-function model, the learning device 30 can estimate the evaluation of actions using Q-functions with relatively small values. This can mitigate overestimation of the evaluation of actions, such as overestimation of the Q-function model. According to the learning device 30, the time required for reinforcement learning can be reduced in this respect.

This allows the learning device 30 to perform learning of the Q-function model by preferentially using experiences with larger errors in the Q-function values, which is expected to improve the errors efficiently.

According to the learning device 30, the time required for reinforcement learning can be reduced in this respect.

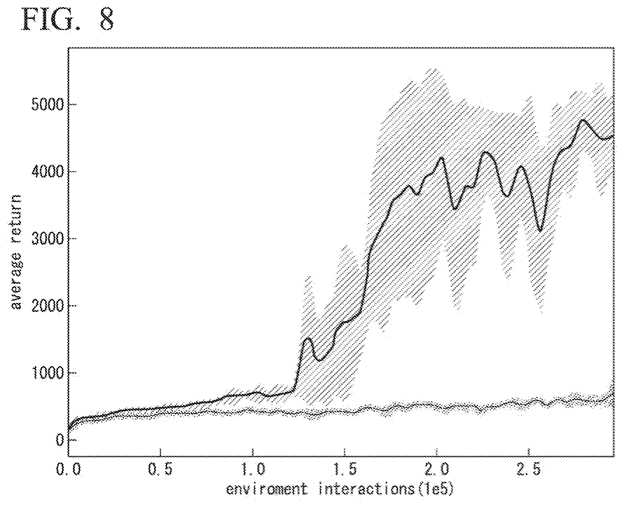

Next, FIG. 8 through FIG. 10 illustrate the results of the verification of the example embodiment. FIG. 8 through FIG. 10 show the results of the verification in the example embodiment.

The distribution in the graph shown in FIG. 8 indicates the relationship between the number of interactions with the environment and the average return of the reward. In the graph shown in FIG. 8, the number of interactions with the environment is set on the horizontal axis and the average return of the reward is set on the vertical axis. From this graph in FIG. 8, the sample efficiency of the reinforcement learning device can be read. The shading in FIG. 8 indicates the range in which reward values varied for each interaction.

For example, the fewer the number of samplings, or number of interactions with the environment, before the average return of the reward reaches a predetermined value, the more efficiently the learning of the reinforcement learning device progresses. The sample efficiencies shown here indicate the overall performance of the learning characteristics of the reinforcement learning device. Within the graph, the higher the position towards the top left, the higher the sample efficiency.

The solid line shows the sample efficiency of the comparative example, while the dashed line shows the sample efficiency of the present example embodiment. The same applies below. From FIG. 8, it can be seen that the results of the present example embodiment (dashed line) are superior to those of the comparative case (solid line) in terms of sample efficiency.

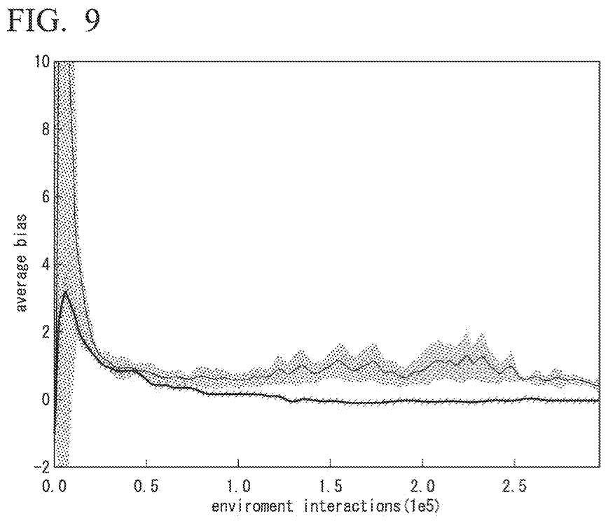

The graph in FIG. 9 shows the performance of overestimation-bias reduction. In the graph shown in FIG. 9, the number of interactions with the environment is set on the horizontal axis and the average difference between actual and estimated results (average bias) is set on the vertical axis. From this graph in FIG. 9, one can read how much the estimated results of the reinforcement learning device deviate from the actual ones. The shaded area in FIG. 9 indicates the range of variations between the estimated results of the reinforcement learning device and the actual results for each interaction.

For example, a value closer to 0 on this vertical axis indicates a more correct estimation, and approaching zero more quickly indicates better performance in reducing the difference between actual and estimated results, known as reduction performance. From FIG. 9, it can be seen that the present example embodiment has better overestimation bias reduction performance than the comparative case.

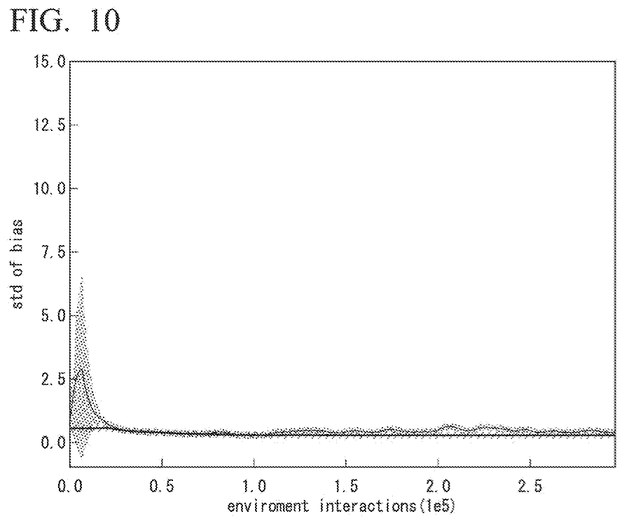

The graph in FIG. 10 shows the performance of reducing the variance of the value of the Q-function. In the graph shown in FIG. 10, the number of interactions with the environment is set on the horizontal axis while the square root of the variance of the Q-function values is set on the vertical axis. From this graph in FIG. 10, it is possible to read whether the estimation of the Q-function is uneven. The shading in FIG. 10 indicates the range over which the square root of the variance of the Q-function varied for each interaction

For example, the closer the standard deviation of the bias is to zero, the better the performance in reducing the variance of the Q-function values. FIG. 10 shows that as long as the number of interactions with the environment is small, the example embodiment has better performance in reducing the variance of the Q-function values than the comparison example.

According to the above example embodiment, the model calculation portion 53 of the learning device 30 uses a plurality of Q-function models (evaluation models) that calculate the Q-function value Qφbarᵢ (second evaluation value) including noise in the index value indicating the evaluation result of the action π_{θ}(s′) in the state s′ to calculate the respective Q-function value Qφbarᵢ (second evaluation value) that includes noise, based on the state s′ (second state) according to the action a (first action) in the state s (first state) of the control target 11 and the action π_{θ}(s′) (second action) calculated from the state s′ using the policy π_{θ} (policy model). The model updating portion 50 updates the policy π_{θ} (policy model) or its parameter variable θ based on the smallest Q-function value Qφbarᵢ (second evaluation value) among multiple Q-function values Qφbarᵢ (second evaluation values) and the reward r (first evaluation value) that is an index value indicating the evaluation result of action a in state s.

The following are examples of several specific applications to illustrate the example embodiment.

### Example Embodiment 1

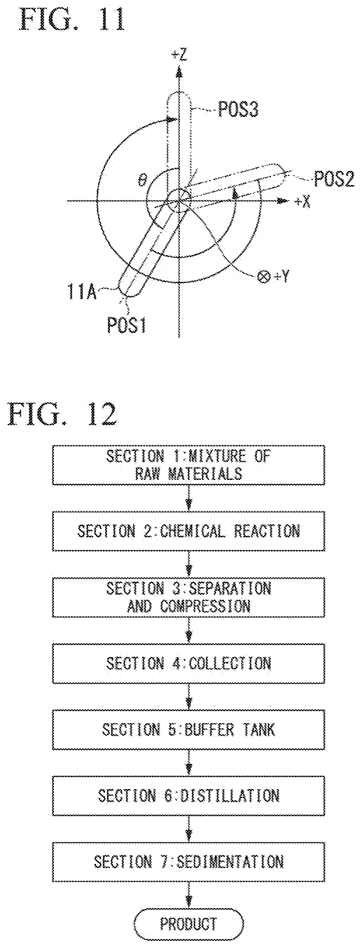

FIG. 11 shows an example of a pendulum to be controlled in Example Embodiment 1.

Example Embodiment 1 describes an example in which the control system 10 inverts a pendulum as shown in FIG. 11. FIG. 11 shows an elevated view of the pendulum from the axial direction. For example, the +X axis is defined in the right direction in FIG. 11, the +Z axis in the upward direction in FIG. 11, and the +Y axis in the depth direction intersecting the plane of FIG. 11. The axis of the pendulum extends in the Y direction. Pendulum 11A in FIG. 11 corresponds to an example of the control target 11. This pendulum 11A has a motor attached to the shaft, and the movement of pendulum 11A can be controlled by the motor.

Here, the objective of Example Embodiment 1 is to make the pendulum 11A invert during the time limit of 100 seconds (position POS3 in FIG. 11) by controlling the motor, and to acquire an automatic control rule (a policy for automatic control) that keeps the inverted state as long as possible through learning.

However, the torque of this motor is not very strong and cannot, for example, move the pendulum 11A from position POS1 directly to position POS3 to invert it. Therefore, to invert the pendulum 11A at position POS1, it must first be moved to position POS2, for example, by applying torque to store some position energy, and then brought to position POS3 by applying moderate torque in the opposite direction.

In Example Embodiment 1, unless otherwise noted, “π” indicates pi and “x” indicates angle.

In Example Embodiment 1, the observer 12 is a sensor that measures the angle x of the pendulum 11A. The angle here is the angle x about the +Y axis extending in the positive orientation of the +Y axis, with the +Z axis direction serving as the reference of the angle, and the range of the angle x of the pendulum 11A is defined as x∈[−π, π], with the clockwise direction of rotation from the +Z axis direction to the +X axis being positive and the counterclockwise direction of rotation being negative. Note that the position POS1 in FIG. 11 corresponds to x=−5π/−6. Position POS2 corresponds to x=5π/12. Position POS3 corresponds to x=0.

The state s of the pendulum 11A shall be expressed in terms of angle x, angular velocity x′, and angular acceleration x″, denoted as (x, x′, x″). In Example Embodiment 1, the position POS1 is the initial position of the pendulum 11A, with the initial angle being −5π/6. Both the initial angular velocity and initial angular acceleration are assumed to be 0.

The state estimation device 13 estimates the angle x, angular velocity x′, and angular acceleration x″ of the true axis from the sensor information of the observer 12, and composes the information of state s=(x, x′, x″). The state estimation device 13 shall perform state estimation every 0.1 second and output state information every 0.1 second. For example, a Kalman filter or the like is used as the algorithm of the state estimation device 13.

The reward calculation device 14 receives information on the state s from the state estimation device 13 and calculates the reward function r(s)=−x². This reward function shall be designed for the purposes of Example Embodiment 1 so that the longer the inversion time, the higher the cumulative reward.

The control implementation device 15 receives the control value c from the control determination device 20 and controls the pendulum 11A. The control value c in Example Embodiment 1 is the voltage V applied to the motor, and the value range of the control value c is [−2V, +2V]. The control implementation device 15 shall continue to apply the same voltage to the motor until a new control value c is received. The control value c indicates the action a of the pendulum 11A.

It is assumed that the processing of the control determination device 20 (Step S103 in FIG. 4), the control implementation device 15 (Step S104 in FIG. 4), and the reward calculation device 14 (Step S105 in FIG. 4) are completed in 0.01 second after the state calculation of the state estimation device 13 (Step S102 in FIG. 4). This means that the control value shall be changed 0.01 second after the state estimation in the state estimation device 13. The control decision interval is 0.1 second, the same as the state estimation interval.

The discrete time labels t=0, 1, 2, 3, . . . are respectively defined as the control start time, (control start time+0.1 second later), (control start time+0.2 second later), and (control start time+0.3 second later). The state vectors estimated for the control start time, (control start time+0.1 second later), (control start time+0.2 second later), (control start time+0.3 second later), . . . are denoted as s₀, s₁, s₂, s₃, . . . , respectively. The control values calculated for the control start time, (control start time+0.1 second later), (control start time+0.2 second later), (control start time+0.3 second later), . . . are denoted as c₀, c₁, c₂, c₃, . . . , respectively. The actions of the pendulum 11A indicated by the control values c₀, c₁, c₂, c₃, . . . are denoted as a₀, a₁, a₂, a₃, . . . , respectively. The reward values calculated for the control start time, (control start time+0.1 second later), (control start time+0.2 second later), (control start time+0.3 second later), . . . are denoted as r₀, r₁, r₂, r₃, . . . , respectively.

The control determination device 20 receives the state s from the state estimation device 13, calculates the policy model by referring to the policy model stored by the policy model storage device 21, and transmits the calculation result as the control value c to the control implementation device 15.

In Example Embodiment 1, the policy model is a fully connected neural network with two hidden layers, where the input layer receives the state s and the output layer outputs the control value c. The number of nodes per hidden layer is 256, and the tanh function is used as the activation function. All parameters of this neural network model are maintained in the policy model storage device 21.

The experience storage device 31 successively records, at each time t, the set (sₜ, cₜ, rₜ, sₜ₊₁), that is, “experience”, of the state sₜ estimated by the state estimation device 13, the control value q output by the control determination device 20, the reward value n output by the reward calculation device 14, and the state sₜ₊₁ estimated by the state estimation device 13 at the next time (t+1). As above, the control value cₜ indicates the action aₜ.

The model stored by the first Q-function model storage device 41 and the model stored by the second Q-function model storage device 42 in the evaluation model storage device 40 are both fully connected neural networks with two hidden layers, as in the policy model, with the number of nodes per hidden layer being 256 and the tanh function being used as the activation function. However, the input layer receives the state and control value pair (s, c), and the output layer outputs the value of Q(s, c).

The experience acquisition portion 34 of the learning device 30 samples the new experience and adds it to the experience storage device 31.

The learning device 30 proceeds with the learning process according to the process shown in FIG. 4 above or the algorithm shown in FIG. 7.

According to the technique of the present example embodiment, in the “inverted pendulum” problem described above, it is possible to acquire a policy model that inverts with “fewer experiences” than in the case where the technique of the present example embodiment is not used.

### Example Embodiment 2

Example Embodiment 2 describes an example in which the control system 10 automatically controls a VAM (vinyl acetate monomer) plant, a type of chemical plant.

The VAM plant simulator is used here as the control target 11, but if the VAM plant simulator sufficiently reproduces reality, it is acceptable to replace the control target 11 with the actual VAM plant after learning the policy model. In Example Embodiment 2, the explanation is based on the assumption that the control target 11 is replaced with an actual VAM plant.

FIG. 12 is a diagram that shows a constituent example of a section in a VAM plant. The VAM plant consists of seven different sections that fulfill different roles.

In Section 1, raw materials for VAM are mixed. In Section 2, chemical reactions occur to produce VAM. Sections 3 to 5 perform separation, compression, and collection of VAM. Sections 6 to 7 carry out distillation and sedimentation of VAM. The VAM obtained in these processes is sold as a product.

The entire VAM plant in Example Embodiment 2 is equipped with about 100 observation devices that measure pressure, temperature, flow rate, etc., and about 30 PID (proportional-integral-derivative) control devices that regulate pressure, temperature, flow rate, and the like. In Example Embodiment 2, the objective is to obtain a policy model that will increase the overall revenue of this VAM plant. Here, overall revenue is the product profit (VAM) minus consumption costs (ethylene, acetic acid, oxygen, electricity, water, etc.).

The control time for the VAM plant is 100 hours, and the ultimate objective is to improve the cumulative total revenue during this control time from the value when the initial state is continued. The initial state here is defined as the state in which the target value of each PID control device is manually adjusted and the VAM plant as a whole reaches a steady state. This initial state is that which is prepared in advance by the VAM plant simulator.

In Example Embodiment 2, the observer 12 consists of approximately 100 of the above-mentioned observation instruments. The VAM plant simulator used can also acquire important physical quantities that cannot be measured by the observations instruments, but they are not used. This is in order to replace the VAM plant simulator with an actual VAM plant.

The state estimation device 13 estimates the true temperature, pressure, flow rate, and other physical quantities from the information in the observer 12 to constitute the state. Assume that state estimation is performed every 30 minutes and that state information is also output every 30 minutes. The algorithm of the state estimation device 13 uses, for example, a Kalman filter.

The reward calculation device 14 receives state s from the state estimation device 13 and calculates the overall revenue, r(s), described above. The calculation method conforms to the VAM plant simulator. The higher the overall revenue, the higher the reward.

The control implementation device 15 receives the control value c from the control determination device 20 and controls the VAM plant simulator. The control value c in Example Embodiment 2 is the target value for each PID control device. The control implementation device 15 maintains the same target value until a new control value c is received. The control value c indicates the action a of the VAM plant.

It is assumed that the processing of the control determination device 20 (Step S103 in FIG. 4), the processing of the control implementation device 15 (Step S104 in FIG. 4), and the processing of the reward calculation device 14 (Step S105 in FIG. 4) are completed within one second of the state calculation of the state estimation device 13 (Step S102 in FIG. 4). This means that the control value shall be changed 1 second after the state estimation in the state estimation device 13. The control decision interval shall be 30 minutes, the same as the state estimation interval.

The discrete time labels t=0, 1, 2, 3, . . . are defined as the control start time, (control start time+30 minutes later), (control start time+60 minutes later), (control start time+90 minutes later), . . . , respectively.

The control determination device 20, policy model storage device 21, learning device 30, experience storage device 31, and evaluation model storage device 40 are the same as in Example Embodiment 1, and so shall not be described here.

The two effects in Example Embodiment 2 are the same as in Example Embodiment 1. As a result, a policy model that improves overall profitability can be obtained with “fewer experiences” compared to the case of not using this technology, and if the VAM plant simulator sufficiently reproduces reality, the policy model can be applied to an actual VAM plant to produce the same overall revenue improvement.

### Example Embodiment 3

Example Embodiment 3 describes a case in which the control system 10 automatically controls a humanoid robot. In Example Embodiment 3, as in Example Embodiment 2, the policy model learned by simulation is applied to the actual control target. In other words, here the control target 11 is a humanoid robot on a simulator, and the policy obtained using the simulator is considered to be applied to an actual humanoid robot.

In Example Embodiment 3, the ultimate goal is to obtain a policy model that allows a humanoid robot to continue walking on two legs without falling over during a control time of 100 seconds. The humanoid robot to be controlled has 17 joints, each with its own motor. The observer 12 includes sensors that measure the angle and torque of each joint and a light detection and ranging (LiDAR) mounted on the head. The simulator used can also acquire important physical quantities that cannot be measured by the observer 12, but they are not used. This is because it applies to actual humanoid robots.

The state estimation device 13 estimates the true angle of each joint, angular velocity, angular acceleration, torque, absolute coordinates of the robot's center of gravity, center of gravity velocity, and load applied to each joint from the information in the observer 12, and configures the state. State estimation is assumed to be performed every 0.1 second, and state information is also assumed to be output every 0.1 second. The algorithm of the state estimation device 13 uses, for example, a Kalman filter, SLAM (Simultaneous Localization And Mapping), or the like.

The reward calculation device 14 takes as input the set (s, c, s′) of the state s output by the state estimation device 13, the control value c output by the control decision device 20, the state output by the state estimation device 13 immediately after the control value c is implemented by the control implementation device 15, that is, the state s′ after the state transition, and calculates the reward function r (s, c, s′). The control value c indicates the action of the robot.

The method of calculating a reward will be in accordance with OpenAI's gym. The basic idea is that the faster the humanoid robot's center of gravity speed in the forward direction, the higher the reward. Also, the more torque the motor produces to save as much power as possible, the more points are deducted. Bonus points are also awarded if the humanoid robot maintains a high center of gravity to prevent it from falling.

The control implementation device 15 receives the control value c from the control determination device 20 and controls the torque of the motor of each joint. It is assumed that the processing of the control determination device 20 (Step S103 in FIG. 4), the control implementation device 15 (Step S104 in FIG. 4), and the reward calculation device 14 (Step S105 in FIG. 4) are completed in 0.01 second after the state calculation of the state estimation device 13 (Step S102 in FIG. 4). This means that the control value shall be changed 0.01 second after the state estimation in the state estimation device 13. The control decision interval is 0.1 second, the same as the state estimation interval. The discrete time label t is defined to match the timing of state estimation similarly to Example Embodiment 1.

The control determination device 20, policy model storage device 21, learning device 30, experience storage device 31, and evaluation model storage device 40 are the same as in Example Embodiment 1, and so shall not be described here.

The two effects in Example Embodiment 3 are the same as in Example Embodiment 1. As a result, compared to the case where the present invention is not used, it is possible to acquire a policy model in which a humanoid robot walks on two legs without falling with “fewer experiences”, and if the humanoid robot model adequately reproduces reality, applying the policy model to an actual humanoid robot can achieve the same overall improvement in revenue.

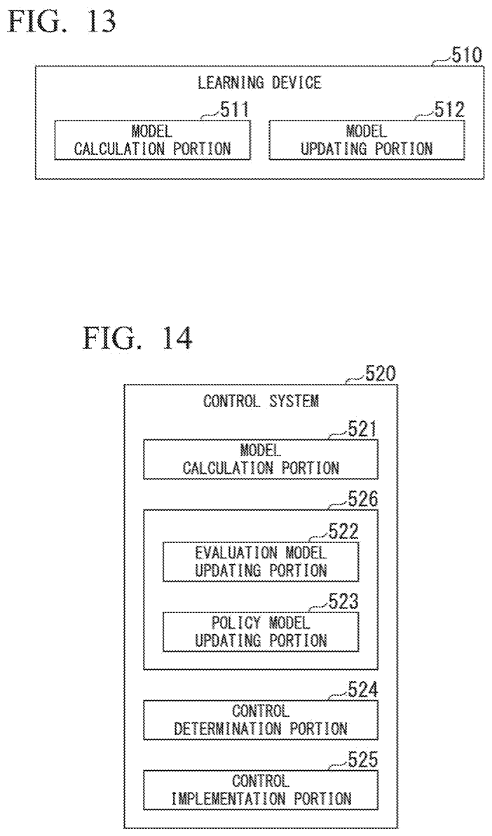

FIG. 13 is a diagram showing a configuration example of the learning device according to the example embodiment. In the configuration shown in FIG. 13, the learning device 510 is provided with a model calculation portion 511 and a model updating portion 512.

In such a configuration, the model calculation portion 511 calculates each of a plurality of second evaluation values using a plurality of evaluation models, each of which calculates, on the basis of both a second state resulting from a first action performed by a control target in a first state, and a second action calculated from the second state using a policy model, a second evaluation value which is an index value of the second action in the second state. The model updating portion 512 updates the policy model or parameters θ of the policy model on the basis of the smallest of the plurality of second evaluation values and a first evaluation value, which is an index value of the first action in the first state.

The model calculation portion 511 is an example of a model calculation means. The model updating portion 512 is an example of a model updating means.

As described above, the model calculation portion 511 in the example embodiment dares to include noise (fluctuation, clutter) in the second evaluation value. In other words, the model calculation portion 511 calculates each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state. The model updating portion 512 updates the policy model or the parameters θ of the policy model on the basis of the smallest of the plurality of second evaluation values respectively calculated and the first evaluation value, which is an index value indicating the result of evaluating the first action in the first state. It goes without saying that one may apply, for example, the goodness of an action or other indicators mentioned above to the evaluation of actions.

Thus, the learning device 510 can estimate the evaluation function using an evaluation function with a relatively small value by learning the evaluation function using multiple evaluation functions. This can mitigate overestimation of the evaluation function, for example, overestimation of the Q-function model. According to the learning device 510, the time required for reinforcement learning can be reduced in this respect.

The model calculation portion 511 can be realized, for example, using functions such as model calculation portion 53 as illustrated in FIG. 3. The model updating portion 512 can be realized, for example, using functions such as model updating portion 50 as illustrated in FIG. 3. Thus, the learning device 510 can be realized using functions such as the learning device 30 as illustrated in FIG. 3.

FIG. 14 is a diagram showing a configuration example of the control system according to the example embodiment. In the configuration shown in FIG. 14, control system 520 is provided with a model calculation portion 521, an evaluation model updating portion 522, a policy model updating portion 523, a control determination portion 524, and a control implementation portion 525.

In such a configuration, the model calculation portion 521 calculates each of a plurality of second evaluation values using a plurality of evaluation models, each of which calculates, on the basis of both a second state resulting from a first action performed by a control target in a first state, and a second action calculated from the second state using a policy model, a second evaluation value which is an index value of the goodness of the second action in the second state. The evaluation model updating portion 522 updates the evaluation model on the basis of the smallest of the plurality of second evaluation values and the first evaluation value, which is an index value of the goodness of the first action in the first state. The policy model updating portion 523 updates the policy model using the evaluation model. The control determination portion 524 calculates control value using the policy model. The control implementation portion 525 controls the control target based on the control value.

The model calculation portion 521 is an example of a model calculation means. The evaluation model updating portion 522 is an example of an evaluation model updating means. The policy model updating portion 523 is an example of a policy model updating means. The control determination portion 524 is an example of a control determination means. The control implementation portion 525 is an example of a control enforcement means.

Thus, the control system 520 can estimate the evaluation function using an evaluation function with a relatively small value by learning the evaluation function using multiple evaluation functions. This can mitigate overestimation of the evaluation function, for example, overestimation of the Q-function model. According to the control system 520, the time required for reinforcement learning can be reduced in this respect.

The model calculation portion 521 can be realized, for example, using functions such as model calculation portion 53 as illustrated in FIG. 3. The evaluation model updating portion 522 can be realized, for example, using functions such as the Q-function model updating portion 51 as illustrated in FIG. 3. The policy model updating portion 523 can be realized, for example, using functions such as the policy model updating portion 52 as illustrated in FIG. 3. The control determination portion 524 can be realized, for example, using functions such as control determination device 20 as illustrated in FIG. 1. The control implementation portion 525 can be realized, for example, using functions such as the control implementation device 15 as illustrated in FIG. 1. Thus, the control system 520 can be realized using the functions of the control system 10 and other systems such as those illustrated in FIGS. 1 through 3.

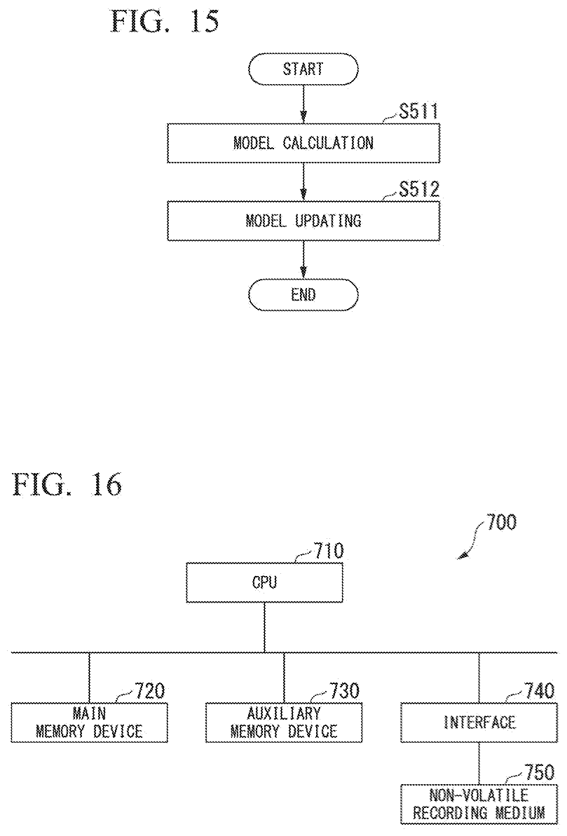

FIG. 15 is a diagram showing an example of the processing procedure in the learning method according to the example embodiment. The learning method shown in FIG. 15 includes a model calculation process (Step S511) and a model updating process (Step S512).

The model calculation process (Step S511) calculates each of a plurality of second evaluation values using a plurality of evaluation models, each of which calculates, on the basis of both a second state resulting from a first action performed by a control target in a first state, and a second action calculated from the second state using a policy model, a second evaluation value which is an index value of the goodness of the second action in the second state. The model updating process (Step S512) updates the evaluation model on the basis of the second evaluation value, which is the smallest of the multiple second evaluation values, and the first evaluation value, which is the index value of the goodness of the first action in the first state.

The learning method shown in FIG. 15 can estimate the evaluation function using an evaluation function with a relatively small value by learning the evaluation function using multiple evaluation functions. This can mitigate overestimation of the evaluation function, such as, overestimation of the Q-function model. According to the learning method in FIG. 15, the time required for reinforcement learning can be reduced in this respect.

FIG. 16 is a schematic block diagram of a computer according to at least one example embodiment.

In the configuration shown in FIG. 16, a computer 700 is provided with a CPU 710, a main memory device 720, an auxiliary memory device 730, an interface 740, and a nonvolatile recording medium 750.

Any one or more of the above learning device 30, learning device 510, and control system 520, or portions thereof, may be implemented in the computer 700. In that case, the operations of each of the above-mentioned processing portions are stored in the auxiliary memory device 730 in the form of a program. The CPU 710 reads the program from the auxiliary memory device 730, deploys it in the main memory device 720, and executes the above processing according to said program. The CPU 710 also reserves a memory area in the main memory device 720 corresponding to each of the above-mentioned storage portions according to the program. Communication between each device and other devices is performed by the interface 740, which has a communication function and communicates according to the control of the CPU 710. The interface 740 also has a port for the nonvolatile recording medium 750 and reads information from and writes information to the nonvolatile recording medium 750.

When the learning device 30 is implemented in the computer 700, the operations of the experience acquisition portion 34, the model updating portion 50, the Q-function model updating portion 51, and the policy model updating portion 52 are stored in the auxiliary memory device 730 in program form. The CPU 710 reads the program from the auxiliary memory device 730, deploys it in the main memory device 720, and executes the above processing according to said program.

The CPU 710 also allocates the storage area corresponding to the mini-batch storage device 35 in the main memory device 720 according to the program.

Communication between the learning device 30 and other devices is performed by the interface 740, which has communication functions and operates according to the control of the CPU 710.

When the learning device 510 is implemented in the computer 700, the operations of the model calculation portion 511 and the model updating portion 512 are stored in the auxiliary memory device 730 in the form of programs. The CPU 710 reads the program from the auxiliary memory device 730, deploys it in the main memory device 720, and executes the above processing according to said program.

The CPU 710 also allocates storage space in the main memory device 720 for the processing performed by the learning device 510 according to the program.

Communication between the learning device 510 and other devices is performed by the interface 740, which has communication functions and operates according to the control of the CPU 710.

When the control system 520 is implemented in the computer 700, the operations of the model calculation portion 521, the evaluation model updating portion 522, the policy model updating portion 523, the control determination portion 524, and the control implementation portion 525 are stored in the auxiliary memory device 730 in program form. The CPU 710 reads the program from the auxiliary memory device 730, deploys it in the main memory device 720, and executes the above processing according to said program.

The CPU 710 also allocates storage space in the main memory device 720 for the processing performed by the control system 520 according to the program.

Communication between the control system 520 and other devices, such as the transmission of control signals from the control implementation portion 525 to the control target, is performed by the interface 740, which has communication functions and operates according to the control of the CPU 710.

Any one or more of the above programs may be recorded on the nonvolatile recording medium 750. In this case, the interface 740 may read the program from the nonvolatile recording medium 750. The CPU 710 may then directly execute the program read by the interface 740, or it may be stored once in the main memory device 720 or the auxiliary memory device 730 and then executed.

A program for executing all or part of the processing performed by the learning device 30, the learning device 510, and the control system 520 may be recorded on a computer-readable recording medium, and the computer system may read and execute the program recorded on this recording medium to perform the processing of each part. The term “computer system” here shall include hardware such as peripheral devices and an operating systems.

In addition, “computer-readable recording medium” means a portable medium such as a flexible disk, magneto-optical disk, ROM (Read Only Memory), CD-ROM (Compact Disc Read Only Memory), or other storage device such as a hard disk built into a computer system. The above program may be used to realize some of the aforementioned functions, and may also be used to realize the aforementioned functions in combination with programs already recorded in the computer system.

The above example embodiments of this invention have been described in detail with reference to the drawings, but specific configurations are not limited to these example embodiments, and also include designs, etc., to the extent that they do not depart from the gist of this invention.

### INDUSTRIAL APPLICABILITY

The example embodiments of the present invention may be applied to a learning device, a learning method, a control system, and a recording medium.

### DESCRIPTION OF REFERENCE SIGNS

10, 520 Control system
11 Control target
12 Observer
13 State estimation device
14 Reward calculation device
15 Control implementation device
20 Control determination device
21 Policy model storage device
30, 510 Learning device
31 Experience storage device
34 Experience acquisition portion
35 Mini-batch storage device
40 Evaluation model storage device
41 First Q-function model storage device
42 Second Q-function model storage device
50, 512 Model updating portion
51 Q-function model updating portion
52, 523 Policy model updating portion
53, 511, 521 Model calculation portion
522 Evaluation model updating portion
524 Control determination portion
525 Control implementation portion

What is claimed is:

1. A learning device comprising:
at least one memory configured to store instructions; and
at least one processor configured to execute the instructions to:
calculate each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and
update the policy model or parameters of the policy model on the basis of the smallest of the plurality of second evaluation values calculated respectively and a first evaluation value, which is an index value indicating the result of evaluating the first action in the first state.

2. The learning device according to claim 1, wherein the at least one processor is configured to execute the instructions to calculate the second evaluation value obtained by including the noise in an operation result based on information pertaining to the policy model, state information pertaining to the first state, and state information pertaining to the second state.

3. The learning device according to claim 1, wherein the at least one processor is configured to execute the instructions to perform an operation to cause inclusion of the noise and an operation that normalizes the result of the operation to cause inclusion of the noise.

4. The learning device according to claim 1, wherein the at least one processor is configured to execute the instructions to normalize the result of the operation to cause inclusion of the noise by using a layer normalization layer.

5. The learning device according to claim 1, wherein the at least one processor is configured to execute the instructions to:
perform a weighting operation on the policy information pertaining to the first action and the state information pertaining to the first state,
add noise to the result of the weighting operation,
normalize the value of the result of the operation to which the noise is added,
identify the normalized results according to predetermined identification rules, and
generate an evaluation value indicating the learning status based on the identification results.

6. The learning device according to claim 5, wherein the at least one processor is configured to execute the instructions to:
perform a weighting operation on the policy information and the state information pertaining to the first state,
add noise to the result of the weighting operation,
normalize the value of the result of the operation to which the noise is added,
identify the normalized results according to predetermined identification rules, and
generate an evaluation value indicating the learning status using a Q-function that generates an evaluation value indicating the learning status based on the identification result.

7. The learning device according to claim 1, wherein the at least one processor is configured to execute the instructions to receive information of at least any one of the following:
the number of Q-functions involved in the update;
the number operation layers that add the noise in the Q-function;
the number of layer normalization layers that normalize the output based on the output of the previous layer in the Q-function; and
the number of times the value propagation calculation is performed according to the operation mode of the control target, and
wherein the at least one processor is configured to execute the instructions to perform the value propagation operation using the received information.

8. A control system comprising:
at least one memory configured to store instructions; and
at least one processor configured to execute the instructions to:
calculate each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and
update the policy model or parameters of the policy model on the basis of the smallest of the plurality of second evaluation values calculated respectively and a first evaluation value, which is an index value indicating the result of evaluating the first action in the first state.

9. A learning method executed by a computer, the learning method comprising:
calculating each of a plurality of second evaluation values that include noise using a plurality of evaluation models, each of which calculates, on the basis of both a second state resulting from a first action performed by a control target in a first state, and a second action calculated from the second state using a policy model, a second evaluation value obtained by including noise in an index value indicating the result of evaluating the second action in the second state; and
updating the policy model or parameters of the policy model on the basis of the smallest of the plurality of second evaluation values calculated respectively and a first evaluation value, which is an index value indicating the result of evaluating the first action in the first state.

10. (canceled)
